(19) United States
(12) Patent Application Publication
(10) Pub. No.: US 2008/0035054 A1
(43) Pub. Date: Feb. 14, 2008

(54) Rim saver

(76) Inventor: Billy Norris Dickens, Memphis, TN (US)

Correspondence Address: Billy N. Dickens Jr., 4635 Tulane RD, Memphis, TN, 38104, US

(21) Appl. No.: 11/502,800

(22) Filed: Aug. 11, 2006

(51) Int. Cl. B05C 21/00

(52) U.S. Cl. 118/504; 15/257.01; 118/505

(57) ABSTRACT

With the use of the “Rim Saver”, you will be able to rapidly shine tires by allowing the user to protect the automobile hubcap from the harsh chemicals used to polish the tire while at the same time, quickly accessing the tire itself. Sizes range from 14″ to 24″ and can be in metric and English units.

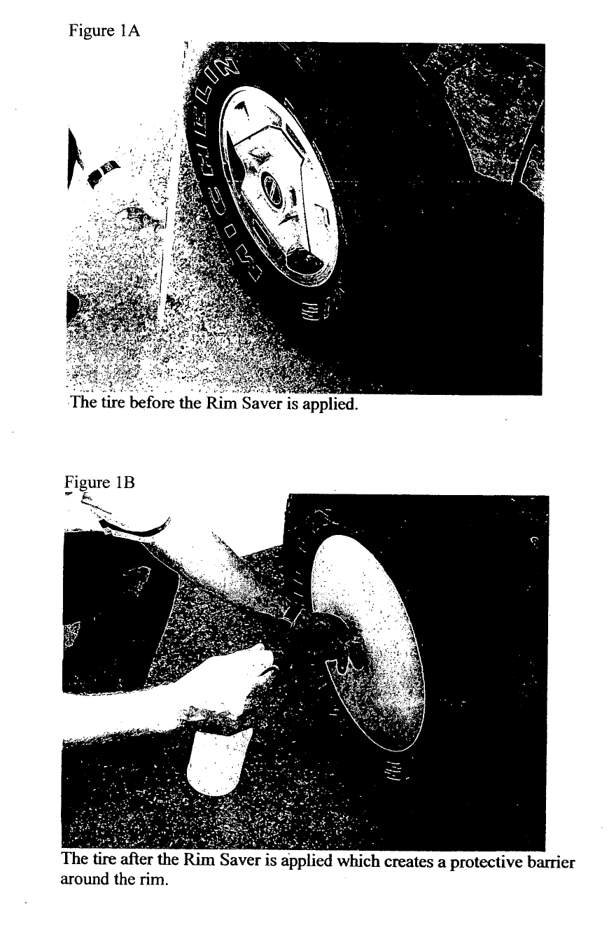

Simply place the Rim Saver on the tire rim, spray the tire shine on your tire and the rim will be saved from excess spray. You can also sponge on the tire shine. Either way will eliminate the need to clean the rim after shining the tire.

### SPECIFICATION

The Rim Saver is design to keep excess tire shine off your rims. It is easy to clean and will save time.

You just set the product over your rims and spray around which will produce clean shine on your tires without over spray on your rims. You will never have to go back and clean your rims due to the unique design of the rim saver.

1. The Rim Saver will keep excess tire shine off your rims.

2. The user won't have to go back and clean their rims.
